(19) United States
(12) Patent Application Publication
(10) Pub. No.: US 2004/0168652 A1
(43) Pub. Date: Sep. 2, 2004

(54) Squeeze chute

(76) Inventor: William Dean Priefert, Mt. Pleasant, TX (US)

Correspondence Address: DAVIS, BROWN, KOEHN, SHORS & ROBERTS, P.C., THE FINANCIAL CENTER, 666 WALNUT STREET, SUITE 2500, DES MOINES, IA, 50309-3993, US

(21) Appl. No.: 10/742,077

(22) Filed: Dec. 19, 2003

Related U.S. Application Data
(60) Provisional application No. 60/434,927, filed on Dec. 19, 2002.

(51) Int. Cl. A01K 15/04

(52) U.S. Cl. 119/733

(57) ABSTRACT

An animal squeeze chute having a side panel tiltable toward an opposing side panel for restraining an animal in the chute. The tiltable panel is moved by an operator-actuated handle and includes a lock which is automatically released when the handle is being operated to tilt the panel toward the opposing panel but locks and prevents movement of the tiltable side panel when the operator releases the handle. The lock is released by movement of the handle in the opposite direction to allow the handle to be operated to return the tiltable side panel to its position away from the opposing side panel and thereby release the animal.

### BACKGROUND OF THE INVENTION

The invention relates generally to an animal restraint device and, more particularly, to a squeeze chute that is used to safely restrain bovine and similar animals for veterinarian and related practices, including but not limited to medical operations, vaccinations, and branding.

Common to all squeeze chutes are a tail gate by which the animal enters the chute from the rear, two sides, at least one of which moves under mechanical power in order to restrain the animal, and a head gate to restrain the neck and head. Usually, the animal exits through the head gate or through an optional side exit gate. Some form of attached floor is common to keep the animal from being able to move the squeeze chute while the animal is restrained. Access doors or panels are normal on the sides for access to specific parts of the body without sacrificing effective restraint of the animal.

### SUMMARY OF THE INVENTION

The invention consists of a tail gate, a left side squeeze panel, a right side emergency exit panel, a floor, side access panels, and a head gate. The squeeze panel is operated by a handle that tilts the squeeze panel toward the opposing exit panel. A lock operated by the handle allows free movement of the squeeze panel when the handle is being moved to tilt the panel toward the opposing exit panel but will automatically lock and prevent reverse tilting of the squeeze panel upon release of the handle. In this way, an operator can quickly and effectively restrain or “squeeze” an animal inside the chute upon movement of the handle toward the restraining position and have the animal held in that position simply by releasing the handle. Once it is desired to release the animal, the handle is moved in the opposite direction. The handle operates to release the lock and move the squeeze panel away from the opposing side panel and release the animal.

The squeeze chute also includes a lock which is used to control the operation of the side emergency exit panel. In a preferred embodiment, the exit panel is mounted for swinging movement on the chute between an open position which would allow an animal to exit the side of the chute and a closed position for retraining the animal. A handle operated the lock to move it from a locked position to an unlocked position. The handle is spring-biased toward the locked position. Preferably, the handle extends to the side of the chute opposite the exit panel.

An object of the present invention is to provide a squeeze chute which is quickly and easily operated between an open position for entry of an animal into the chute and a locked, animal restraining position merely by movement of a handle by an operator.

Another object of the invention is to provide a squeeze chute having an emergency exit panel that allows the chute to be quickly and easily opened along a side to permit an animal to exit the squeeze chute through the side rather than through the head gate.

These and other objects of the invention will be apparent to those skilled in the art upon a review of this specification, the associated drawings and appended claims.

### BRIEF DESCRIPTION OF THE DRAWINGS

FIG. 1 is an upper left perspective view of a squeeze chute of the present invention.

FIG. 2 is an upper right perspective view of a squeeze chute of the FIG. 1.

FIG. 3 is an upper left perspective view of the squeeze chute of FIG. 1 wherein a side panel has been swung open.

FIG. 4 is an enlarged fragmentary view of a side exit linkage of the present invention in a locked position.

FIG. 5 is an enlarged view of a side exit latch with phantom lines showing the interior latch member in a locked position.

FIG. 6 is an enlarged fragmentary view of a side exit linkage of the present invention in an unlocked position.

FIG. 7 is an enlarged view of a side exit latch with phantom lines showing the interior latch member in an unlocked position.

FIG. 8 is a side view of the latch in the locked position showing capture of a latch rod.

FIG. 9 is a side view of the latch in the unlocked position showing release of the latch rod.

### DETAILED DESCRIPTION OF A PREFERRED EMBODIMENT

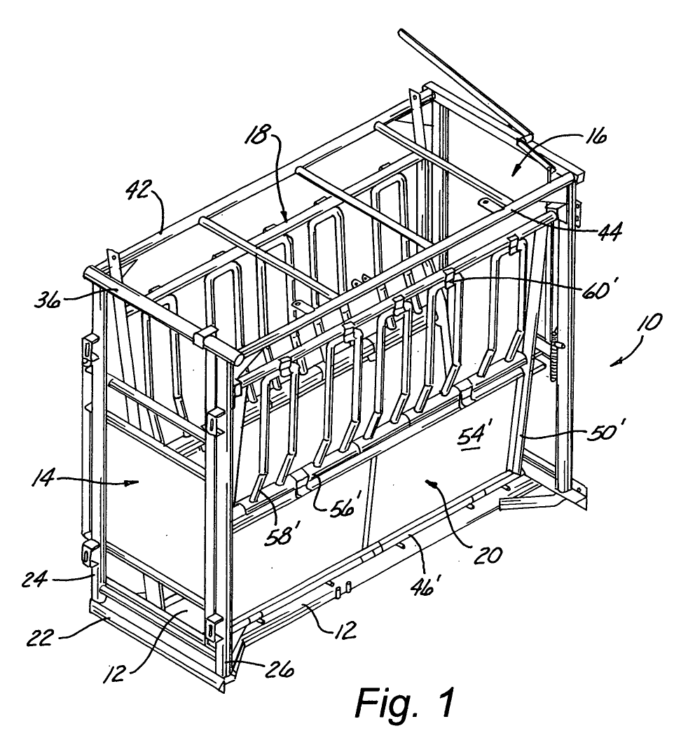

Illustrated in FIGS. 1, 2, and 3 generally at 10, is a squeeze chute of the present invention. The squeeze chute 10 includes a floor 12, a tail or entry gate 14, a head gate 16, a left side squeeze panel 18, and a right side panel 20 which also serves as an emergency exit. The tail gate 14 includes a bottom frame rail 22 that is rigidly secured to a left upright frame member 24 and a right upright frame member 26. A top frame rail 36 is secured to top end portions of the frame members 24 and 26. Correspondingly, the head gate 16 includes a bottom frame rail 30 that is rigidly secured to a left upright frame member 32 and a right upright frame member 34. A top frame rail (not shown) is secured to top end portions of the frame members 32 and 34 and supports a turn shaft 28 for pivotal movement about a horizontal axis inside a stationary tube 29. The tail gate 14 and head gate 16 are interconnected at the bottom by the floor 12 and at the top by a pair of top longitudinal rails 42 and 44 thereby forming a rigid frame of the squeeze chute 10.

The left side squeeze panel 18 is mounted for pivotal movement about a horizontal, longitudinal axis toward and away from the longitudinal centerline of the squeeze chute 10. The panel 18 includes a bottom rail 46 and a top rail 48 that are rigidly connected to each other by a pair of upright rails 50 and 52, thereby forming a roughly rectangular panel. A solid bottom wall 54 is positioned above the bottom rail 46 extending the full length of the panel 18 and approximately one-half of the height of the panel 18. The solid wall 54 will prevent an animal inside the squeeze chute 10 from being able to kick an operator or assistant positioned outside the squeeze chute 10. A horizontal pivot rail 56 interconnects the upright rails 50 and 52 above the solid wall 54. A plurality of access tubes 58 are mounted at their bottom end portions on the pivot rail 56 for pivotal movement about the pivot rail 56. The top of each access tube 58 is releasably secured to the top rail 48 by a corresponding releasable catch 60. When captured by the catch 60, the access tubes 58 prevent an animal inside the squeeze chute 10 from exiting above the solid wall 54. Once an animal is restrained in the squeeze chute 10, an operator may release one or more of the access tubes 58 to gain access to the restrained animal for performing a veterinary or animal husbandry procedure.

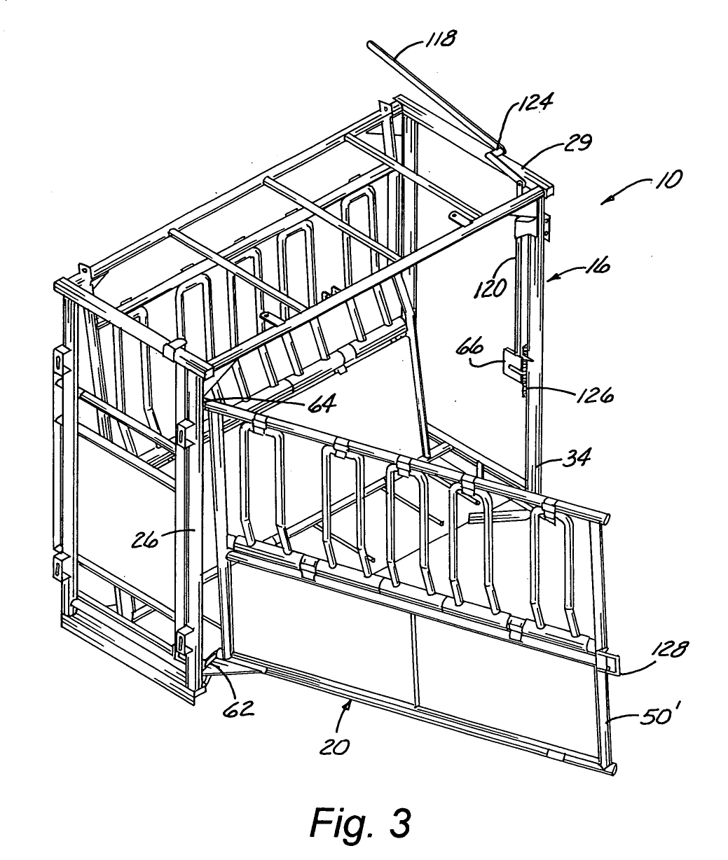

The right side panel 20 is similar in construction to the left side panel 18 with similar or corresponding parts identified by the same reference numeral which has been further identified by a “prime” so that, for example, the solid wall of the right side panel bears the reference numeral 54′. The right side panel 20 is, however, mounted on the frame of the squeeze chute 10 in a different manner than the left side squeeze panel 18 as it performs a distinct function. As recited above, the left side squeeze panel 18 is mounted for pivotal movement about a bottom horizontal axis for movement toward and away from the centerline of the squeeze chute 10. The left side panel 18, accordingly, can be pivoted to an open position away from the center of the chute 10 when an animal is entering the chute 10 and then pivoted inwardly once the animal is inside the chute 10 to “squeeze” the animal between the side panels 18 and 20 and so further restrain its movement while inside the chute 10. The right side panel 20, however, functions to provide an emergency escape for an animal in a distressed situation in the chute 10. The panel 20 is mounted for swinging movement about a vertical axis by a pair of hinges 62 and 64 which mount the side panel 20 on the right upright frame member 26 of the tail gate 14 (FIG. 3). A two-position latch 66 on the right upright frame member 34 of the head gate 16 has a locked position in which it holds the closed panel 20 in the closed position until manually released by an operator, and an unlocked position where it will yieldably restrain the side panel 20 in the closed position until an animal in the chute exerts an opening pressure on the side panel 20, both as will be described in more detail below.

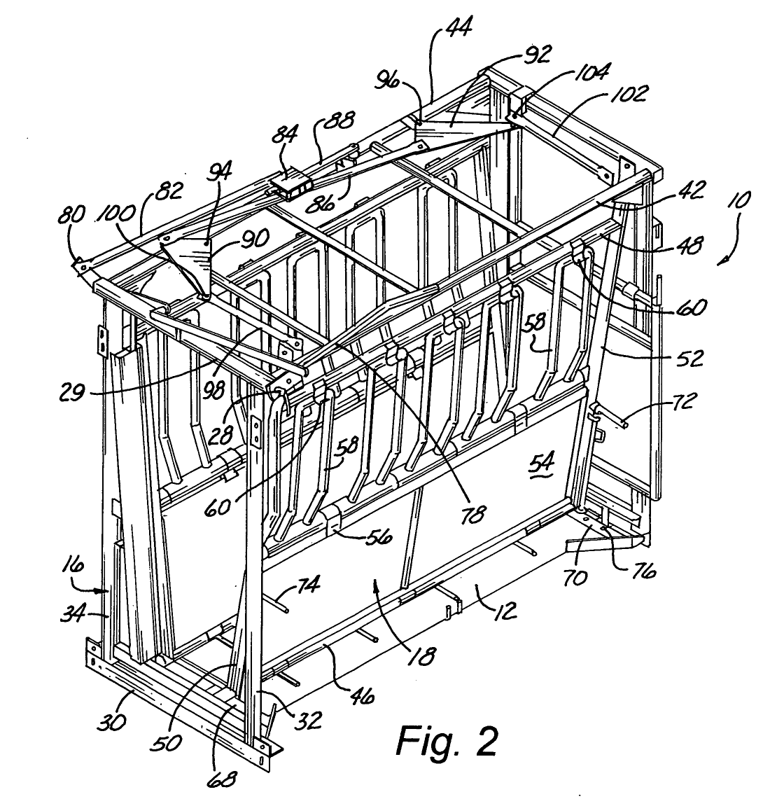

One of the challenges of a squeeze chute is to reliably restrain animals of a variety of sizes. If the space between the side panels is large, the chute may reliably restrain large animals but not be able to move the side panels sufficiently close together to be able to reliably restrain or “squeeze” a smaller animal. In the squeeze chute 10 of the present invention, this challenge is addressed by providing a mechanism for quickly and easily sliding the bottom mounting point of the right side panel 20 at a variety of positions closer to or farther away from the left side panel 18. This is accomplished by including a track 68 on the bottom rail 22 and a track 70 on the bottom rail 30 (FIG. 2). A rod 72 is mounted for vertical movement along the bottom end portion of the upright rail 52 and a rod 74 is mounted for vertical movement along the bottom end portion of the upright rail 50. The tracks 68 and 70 each have four, spaced-apart holes 76 into which is received the lower end portion of the rods 72 and 74. Accordingly, the position of the right side panel 20 is adjustable by withdrawing the rods 72 and 74 from their corresponding holes 76, sliding the panel 20 to the desired adjusted position, and reinserting the rods 72 and 74 into the adjusted pair of aligned holes 76. In this way, animal from large bulls to small calves by be reliably restrained in the squeeze chute 10.

Another challenge of a squeeze chute is to permit an operator to quickly and reliably trip the squeeze chute from an open or non-restraining condition to a restraining condition and then hold or lock the restrained condition until released by the operator. Animals are notorious for refusing to enter what appears to be a closed or confined space. It is important, therefore, that the squeeze chute have an open condition where the animal will not recognize that it is a place that may be confining. However, once the animal has entered the squeeze chute, it must quickly close and restrain the animal so that it cannot easily exit the chute until permitted by the operator. These somewhat conflicting functions are at least partially achieved in the present squeeze chute 10 by the pivoting motion of the left side or squeeze panel 18. When pivoted outwardly, the left side panel 18 creates an open pathway through the squeeze chute 10, but when pivoted inwardly will “squeeze” and effectively restrain the animal inside the chute 10. The pivoting motion and locking of the squeeze panel 18 in the present invention is accomplished by a novel linkage.

As illustrated in FIG. 2, the linkage includes a squeeze handle 78 that is attached to an end of the turn shaft 28 so that raising and lowering of the handle 78 will pivot the turn shaft 28 counterclockwise and clockwise, respectively. A radially extended ear 80 is mounted on the end of the turn shaft 28 opposite of the handle 78. An arm 82 is pivotally attached at the free end portion of the ear 80 and extends rearwardly and generally parallel to the top frame rail 44. The rearward end portion of the arm is attached to a lock box 84, the bottom of which is mounted at a position centrally of a lock box arm 86. A lock bar 88 is mounted on the top frame rail 44 and extends into the lock box 84. The forward end portion of the lock box arm 86 is pivotally attached to a vertex of a first triangular plate 90 and the rearward end portion of the lock box are 86 is pivotally attached to a second triangular plate 92. The plates 90 and 92 are mounted at vertices 94 and 96, respectively, to the squeeze chute frame for pivotal movement relative thereto.

In operation, when an animal enters the chute 10 and has its head positioned past the head gate 16, the operator pulls downwardly on the handle 78, pivoting both the turn shaft 28 and the ear 80 which causes the arm 82 to move rearwardly. This in turn pushes the lock box 84 along the lock bar 88. Once downward movement of the handle 78 stops, the lock box 84 will lock onto the lock bar 88 and prevent forward movement of the arm 82. Since the lock box 84 is affixed to the lock box arm 86, the lock box arm 86 it is moved rearwardly along with the lock box 84. Rearward movement of the lock box arm 86 pivots the first triangular plate 90 clockwise and simultaneously pivots the second triangular plate 92 counterclockwise. A forward transverse arm 98 is pivotally attached at the third vertex 100 of the first triangular plate 90 and a rearward transverse arm 102 is pivotally attached at the third vertex 104 of the second triangular plate 92. The opposite ends of the transverse arms 98 and 102 are attached to the top rail 42 of the left side or squeeze panel 18. Accordingly, the clockwise pivotal movement of the first triangular plate 90 and the counterclockwise pivotal movement of the second triangular plate 92 will pull the top of the squeeze panel 18 toward the center of the chute 20 and this “squeeze” and restrain the animal in the chute 10. Pulling the handle 78 upwardly will release the lock box 84 and pivot the left side panel 18 back toward its open or unrestraining position.

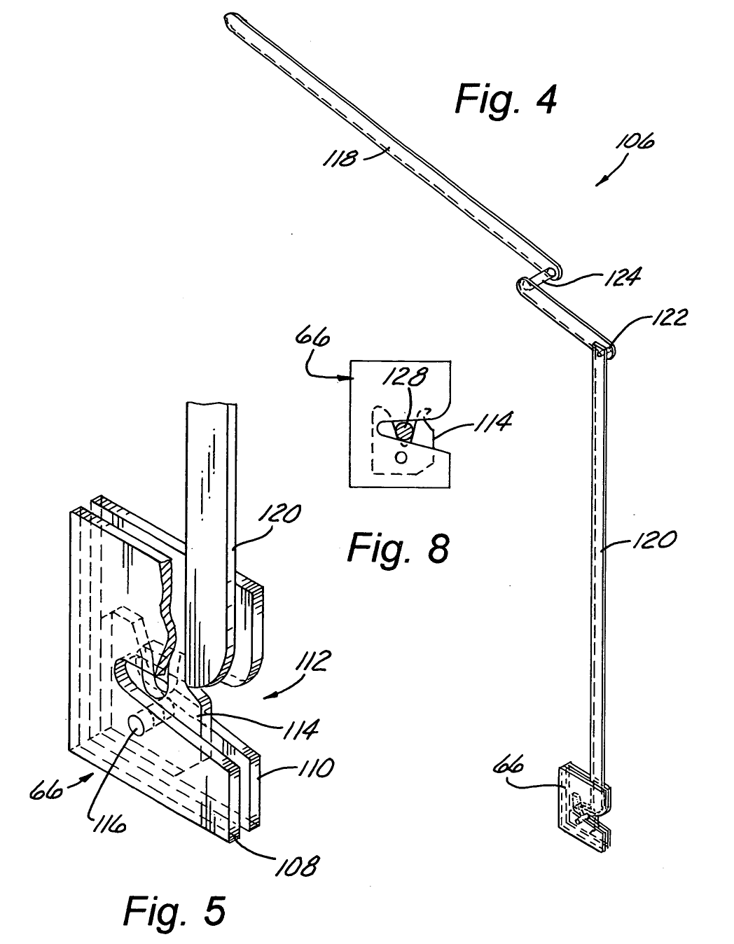

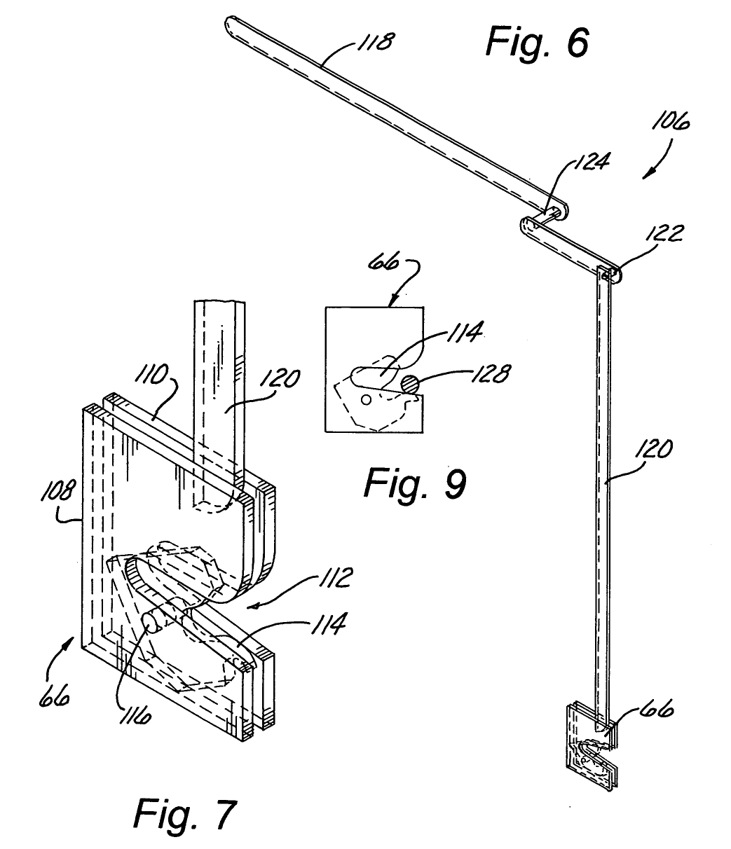

The side exit is a feature that is important for the safety of the animal and convenience of the operator. If an animal lies down in the chute 10 and will not get up, the side exit panel 20 can be opened (FIG. 3) to let the animal have more room to get up and out of the squeeze chute 10. Control of the opening of the side exit panel 20 is obtained by the latch 66 and an associated latch release linkage, illustrated in FIGS. 4 and 6, generally at 106. The latch 66, as illustrated in FIGS. 5 and 7, is comprised of a pair of identical, spaced apart plate members 108 and 110 that are provided with an opening 112. A lock plate 114 is supported for pivotal movement inside the plate members 108 and 110 on a pivot pin 116 received in the plate members 108 and 110. The lock plate 114 pivots about pin 116 between an unlocked position (FIGS. 4 and 5) and a locked position (FIGS. 6 and 7).

The linkage 106 includes a side exit handle 118 and a lock release bar 120 that are pivotally interconnected by a pivot 122 (FIGS. 4 and 6). A pivot tube 124 receives a section of the side exit handle 118 and is secured to the stationary tube 29 (FIG. 3) so that downward movement of the handle 118 will raise the lock release bar 120. A spring 126 is connected between the upright frame member 34 and the lock release bar 120 to bias the lock release bar 120 and side exit handle 118 toward the locked position of the latch 66. A U-shaped rod 128 is mounted on the upright rail 50′ of the side panel 20 so that a portion of it is received inside the opening 112 of the latch 66 as the side panel 20 is moved to its closed position. Closing the side panel 20, accordingly, will pivot the lock plate 114 from the unlocked position (FIG. 9) to the locked position (FIG. 8) whereupon the spring 126 will pull the lock release bar 120 down and thereby prevent release of the rod 128 from the latch 66 until the side exit handle 118 is lowered by an operator.

Another use of the side exit is for sorting animals. The opening of the head gate 16 can be used to sort animals into one pen while the side exit can open into a different pen. When the side exit latch 66 is unlocked, the pressure of an animal against the side exit gate pushes the gate 20 open. A rope can be used to pull the gate 20 shut or the operator can walk to the other side and push it shut. To unlatch the gate 20, the operator can pull the side exit handle 118 downward. The handle pivots and raised the lock release bar 120 releasing the lock plate 114 to rotate at pivot 112, which releases rod 128 and lets the gate 20 open. Spring 126 holds tension on the lock-release bar 120 so that when the gate 20 is pulled shut rod 120 pushes against the lock plate 114 and rotates it back and the lock-release bar 120 falls back into its locked position. The lock plate 114 is an extremely positive lock and easy to release under pressure.

The foregoing description comprises illustrative embodiments of the present inventions. The foregoing embodiments and the methods described herein may vary based on the ability, experience, and preference of those skilled in the art. Merely listing the steps of the method in a certain order does not necessarily constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the claims.

I claim:

1. In an animal squeeze chute having a head gate, a first, tiltable side panel and a second, opposing side panel, the improvement comprising:
(a) a squeeze handle mounted on the squeeze chute for movement between an animal restraining position and an animal release position;
(b) a linkage interconnecting the squeeze handle and the tiltable side panel for tilting the side panel toward the opposing side panel into an animal restraining position as the squeeze handle is moved to the animal restraining position; and
(c) a lock operated by movement of the squeeze handle which permits free motion of the tiltable side panel toward the opposing side panel when the squeeze handle is being moved toward the animal restraining position and locks to prevent movement of the tiltable side panel away from the opposing side panel when the squeeze handle is released.

2. The animal squeeze chute of claim 1, wherein the lock is released upon movement of the squeeze handle toward the animal release position and the linkage tilts the tiltable side panel away from the opposing side panel upon movement of the squeeze handle toward the animal release position.

3. The animal squeeze chute of claim 1, wherein the linkage comprises:
(a) a bar moveable by the squeeze handle;
(b) a first pivot member interconnecting the tiltable side panel and a first end portion of the bar;
(c) a second pivot member interconnecting the tiltable side panel and a second end portion of the bar; and
(d) wherein movement of the bar by the squeeze handle tilts the tiltable side panel.

4. The animal squeeze chute of claim 1, further comprising a panel support structure on which the tiltable side panel is mounted for pivotal movement wherein the panel support structure comprises a plurality of transversely spaced apart stations for adjusting the spacing between the panels when in the animal release position.

5. In an animal squeeze chute having a head gate, a first, opening side panel and a second, opposing side panel, the improvement comprising:
(a) a latch release handle mounted on the squeeze chute for movement between an opening side panel locked position and an opening side panel unlocked position; and
(b) a latch operated by movement of the latch release handle which releases for opening movement the opening side panel when the lock release handle is moved to the opening side panel unlocked position and locks to prevent opening of the opening side panel when the lock release handle is released.

6. The animal squeeze chute of claim 5, further comprising a spring for biasing the latch release handle toward the side panel locked position.

7. The animal squeeze chute of claim 5, wherein the latch release handle extends to the side of the chute adjacent the opposing side panel.

8. The animal squeeze chute of claim 5, wherein the opening panel is mounted for swinging movement between a closed position and an open position.
